(19) United States
(12) Patent Application Publication
(10) Pub. No.: US 2013/0047995 A1
(43) Pub. Date: Feb. 28, 2013

(54) MASK

(71) Applicants: Akira Shibata, Kagawa (JP); Eisuke Takeda, Kagawa (JP)

(72) Inventors: Akira Shibata, Kagawa (JP); Eisuke Takeda, Kagawa (JP)

(21) Appl. No.: 13/579,518

(22) PCT Filed: Feb. 18, 2011
(86) PCT No.: PCT/JP2011/053573

§ 371 Date: Oct. 17, 2012

(30) Foreign Application Priority Data
Feb. 19, 2010 (JP) 2010-035449

(51) Int. Cl. A62B 18/08

(52) U.S. Cl. 128/863

(57) ABSTRACT

A mask that includes a mask body, a left ear loop, and a right ear loop. The left and right ear loops each comprise a base and a rim that extends from the base and forms an opening. The ear loops are laid out on the contact surface of the mask body such that the rims are inwards of the bases. The bases are joined to the mask body by means of left and right joining parts, each of which has a top joining part, a middle joining part, and a bottom joining part. When the mask is worn, the left ear loop (or right ear loop) is folded at the left joining part (or right joining part).

### BACKGROUND OF THE INVENTION

1. Field of the Invention

The present invention relates to a technique of constructing a mask which covers a mouth and a nose of a wearer.

2. Description of the Related Art

A mask which covers wearer's mouth and nose is disclosed, for example, in Japanese non-examined laid-open Patent Publication No. 3-34195. This known mask includes a mask body which covers a wearer's mouth and left and right ear straps. The left and right ear straps are fusion bonded to the mask body.
Prior art reference: Japanese non-examined laid-open Patent Publication No. 3-34195

### SUMMARY OF THE INVENTION

In the known mask, bonding parts for bonding the mask body and the left and right ear straps are exposed on a wearing face (wearer side) of the mask body. Therefore, the hard bonding parts of the mask body may come in contact with a wearer's skin.

Accordingly, it is an object of the present invention to provide an effective technique for preventing bonding parts of a mask from coming in contact with a wearer's skin.

A mask according to the present invention may be of disposable type designed for single use, disposable type designed for multiple use which can be used several times or reusable type which can be reused by washing.

In one invention, the mask has at least the mask body and first and second ear straps. The mask body is designed to cover a mouth and a nose of a wearer. The left and right ear straps are designed to be hooked around left and right ears of the wearer. The first and second ear straps are bonded to the mask body by a first bonding part and a second bonding part, respectively, which are located away from each other in a first direction respectively.

Further, the first ear strap and the second ear strap are hooked around the left and right ears of the wearer, respectively. The “first direction” represents a longitudinal direction (width direction) of the mask body and corresponds to a horizontal direction when viewed from a wearer wearing the mask. One direction to “one side in the first direction” represents a direction from the first ear strap toward the second ear strap and corresponds to a direction from left to right when viewed from the wearer wearing the mask. The other direction to “the other side in the first direction” represents a direction from the second ear strap toward the first ear strap and corresponds to a direction from right to left when viewed from the wearer wearing the mask.

The mask body and the first and second ear straps are typically formed by bonding one or more sheet pieces. The mask body can have a planar or three-dimensional form, but it is preferably designed to take a three-dimensional form at least when the mask is worn. For example, the mask body is designed to be planar when the mask is not worn (not in use) and to take a three-dimensional form when the mask is worn (in use). As such a mask body, for example, a pleated-type mask body having a plurality of pleats extending in parallel is used.

A sheet piece forming the mask body and the first and second ear straps is formed by fixing or intertwining fibers, for example, by mechanical, chemical or heat treatment. Typically, the sheet piece comprises a nonwoven fabric sheet which partly includes heat fusible synthetic fibers (thermoplastic synthetic fibers) and can be fusion bonded. The mask body and the first and second ear straps may be integrally formed in one piece, or they may be separately formed. The first and second ear straps are suitably formed of a stretch nonwoven fabric sheet piece.

In order to bond the first and second ear straps to the mask body, various bonding methods such as fusion bonding and adhesive bonding can be used. The first and second bonding parts consist of bonding portions which have various shapes such as a linear shape (a straight line or a curved line) and a point-like shape and are arranged along a line (a straight line or a curved line) or discontinuously.

The first ear strap has a first base which is bonded at least in part to one face of the mask body by the first bonding part. Further, the first ear strap has a first rim which extends from the first base to one side in the first direction and defines an opening. The “one face of the mask body” typically corresponds to a wearing face (wearer side) of the mask body. The “first rim” is a part to be hooked around one ear (for example, the left ear) of the wearer.

The second ear strap has a second base which is bonded at least in part to the one face of the mask body by the second bonding part. Further, the second ear strap has a second rim which extends from the second base to the other side in the first direction and defines an opening. The other direction to “the other side” corresponds to a direction from the second ear strap toward the first ear strap along the first direction. The “second rim” is a part to be hooked around the other ear (for example, the right ear) of the wearer.

At least when the mask is worn, the first ear strap is folded back along the region of the first bonding part in the first direction and part of the folded portion is disposed between the first bonding part and the wearer. Further, the second ear strap is folded back along the region of the second bonding part in the first direction and part of the folded portion is disposed between the second bonding part and the wearer. Specifically, the first bonding part is covered by part of the first ear strap (part of the folded portion) and the second bonding part is covered by part of the second ear strap (part of the folded portion). Further, the first and second bonding parts are preferably covered in their entirety, but they may be covered at least in part.

In the present invention, at least when the mask is worn, the first bonding part is covered by part of the first ear strap and the second bonding part is covered by part of the second ear strap, so that the first and second bonding parts can be prevented from coming in contact with the wearer's skin. Further, in the mask according to the present invention, when the mask is not worn, the first and second ear straps are overlaid on the mask body, so that the mask is easy to pack and easy to carry.

In a different embodiment of the invention, the first base has at least a first upper base and a first lower base which are located away from each other in a second direction transverse to the first direction. The first lower base is disposed to one side in the second direction with respect to the first upper base. The first rim extends from the first upper base and the first lower base. Further, at least part of the first upper base and at least part of the first lower base are bonded to the one face of the mask body by the first bonding part. Similarly, the second base has at least a second upper base and a second lower base which are located away from each other in the second direction transverse to the first direction. The second lower base is disposed to one side in the second direction with respect to the second upper base. The second rim extends from the second upper base and the second lower base. Further, at least part of the second upper base and at least part of the second lower base are bonded to the one face of the mask body by the second bonding part.

Further, the “second direction transverse to the first direction” represents a direction (a height direction) transverse to the longitudinal direction of the mask body and corresponds to a vertical direction with respect to the wearer wearing the mask. One direction to “one side in the second direction” represents a direction from the upper edge toward the lower edge of the mask body and corresponds to a direction from top to bottom of the wearer wearing the mask. The other direction to “the other side in the second direction” represents a direction from the lower edge toward the upper edge of the mask body and corresponds to a direction from down to top of the wearer wearing the mask.

In this embodiment, the first bonding part is covered by a portion of the first upper base between the first bonding part and the first rim and by a portion of the first lower base between the first bonding part and the first rim. Further, the second bonding part is covered by a portion of the second upper base between the second bonding part and the second rim and by a portion of the second lower base between the second bonding part and the second rim.

In a further different embodiment of the invention, the first base has a first upper base, a first middle base and a first lower base which are disposed in order from the other side to one side in the second direction transverse to the first direction. The first rim extends from the first upper base and the first lower base. Further, at least part of the first upper base, at least part of the first middle base and at least part of the first lower base are bonded to the one face of the mask body by the first bonding part. Similarly, the second base has at least a second upper base, a second middle base and a second lower base which are disposed in order from the other side to the one side in the second direction. The second rim extends from the second upper base and the second lower base. Further, at least part of the second upper base, at least part of the second middle base and at least part of the second lower base are bonded to one face of the mask body by the second bonding part. The “second direction transverse to the first direction” represents a direction transverse to the longitudinal direction of the mask body and corresponds to a vertical direction with respect to the wearer wearing the mask.

In this embodiment, the first bonding part is covered by a portion of the first upper base between the first bonding part and the first rim, a portion of the first middle base on the first rim side of the first bonding part, and a portion of the first lower base between the first bonding part and the first rim. Further, the second bonding part is covered by a portion of the second upper base between the second bonding part and the second rim, a portion of the second middle base on the second rim side of the second bonding part, and a portion of the second lower base between the second bonding part and the second rim. With such a construction, the strength of bonding between the mask body and the first and second ear straps can be increased while the bonding part is prevented from coming in contact with the wearer's skin.

In a further embodiment of the invention, the first bonding part is provided in the first upper base such that an end portion of the first bonding part on the one side in the second direction is disposed to the opposite side of an end portion of the first bonding part on the other side in the second direction from the first rim in the first direction. Further, the second bonding part is provided in the second upper base such that an end portion of the second bonding part on the one side in the second direction is disposed to the opposite side of an end portion of the second bonding part on the other side in the second direction from the second rim in the first direction.

In this embodiment, space can be prevented from being formed between the mask body and the wearer in the regions of the first and second upper bases.

In a further different embodiment of the invention, the first and second bonding parts are provided along the second direction. It is essential for the first and second bonding parts to be provided in order along the second direction, and each of the bonding part can be arranged in various manners, for example, along a straight line.

In this embodiment, a portion of the first ear strap on the first rim side of the first bonding part and a portion of the second ear strap on the second rim side of the second bonding part can be easily folded back.

A mask of a different invention includes at least a mask body and first and second ear straps. The first and second ear straps are bonded to the mask body by first and second bonding parts, respectively, which are located away from each other in the first direction. The “first direction” is defined as described above.

The first ear strap has a first base which is bonded at least in part to one face of the mask body by the first bonding part. Further, the first ear strap has a first rim which extends from the first base to one side in the first direction and defines an opening.

The second ear strap has a second base which is bonded at least in part to one face of the mask body by the second bonding part. Further, the second ear strap has a second rim which extends from the second base to the other side in the first direction and defines an opening.

At least when the mask is worn, part of the first ear strap is disposed between the first bonding part and the wearer, and part of the second bonding part is disposed between the second bonding part and the wearer. For example, the first and second ear straps are bonded to the mask body in such a manner that the first bonding part is covered by part of the first ear strap by folding back the first ear strap (the left ear strap) and the second bonding part is covered by part of the second ear strap by folding back the second ear strap (the right ear strap). Alternatively, the first and second ear straps are bonded to the mask body in such a manner that the first bonding part and the second bonding part are covered by part of the first ear strap and part of the second ear strap, respectively.

In the present invention, the first and second bonding parts can be prevented from coming in contact with the wearer's skin.

In a further different embodiment of each of these inventions, the mask body has a plurality of pleats extending in the first direction. The pleats are bonded together at one end on one side in the first direction (for example, a left end) by the first bonding part and also bonded together at the other end on the other side in the first direction (for example, a right end) by the second bonding part. Specifically, the mask body is of a pleated type which takes a three-dimensional form when the mask is worn. The first and second rims extend in a band-like form from the first and second bases, respectively.

In the mask of this embodiment, the effect obtained by using each of the features or structures described above can be more effectively produced.

### Effect of the Invention

In the mask of the present invention, the bonding parts of the mask can be prevented from coming in contact with the wearer's skin, so that the wearer can comfortably wear the mask. Other objects, features and advantages of the present invention will be readily understood after reading the following detailed description together with the accompanying drawings and the claims.

### BRIEF DESCRIPTION OF THE DRAWINGS

FIG. 1 shows a mask according to an embodiment, as viewed from a non-wearing face side when the mask is not worn.

FIG. 2 shows the mask of the embodiment as viewed from a wearing face side when the mask is not worn.

FIG. 3 shows the mask of the embodiment as viewed from the wearing face side when the mask is worn.

FIG. 4 shows a mask body when the mask is not worn.

FIG. 5 shows the mask body when the mask is worn.

FIG. 6 is a sectional view taken along line VI-VI in FIG. 3 as viewed from the direction shown by the arrow.

FIG. 7 shows a different embodiment of a bonding part.

FIG. 8 shows a different embodiment of the bonding part.

FIG. 9 shows a different embodiment of the bonding part.

FIG. 10 shows a mask according to another embodiment, as viewed from the non-wearing face side when the mask is not worn.

### DETAILED DESCRIPTION OF THE INVENTION

Each of the additional features and method steps disclosed above and below may be utilized separately or in conjunction with other features and method steps to provide and manufacture improved masks and method for using such masks and devices utilized therein Representative examples of the present invention, which examples utilized many of these additional features and method steps in conjunction, will now be described in detail with reference to the drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed within the following detailed description may not be necessary to practice the invention in the broadest sense, and are instead taught merely to particularly describe some representative examples of the invention, which detailed description will now be given with reference to the accompanying drawings.

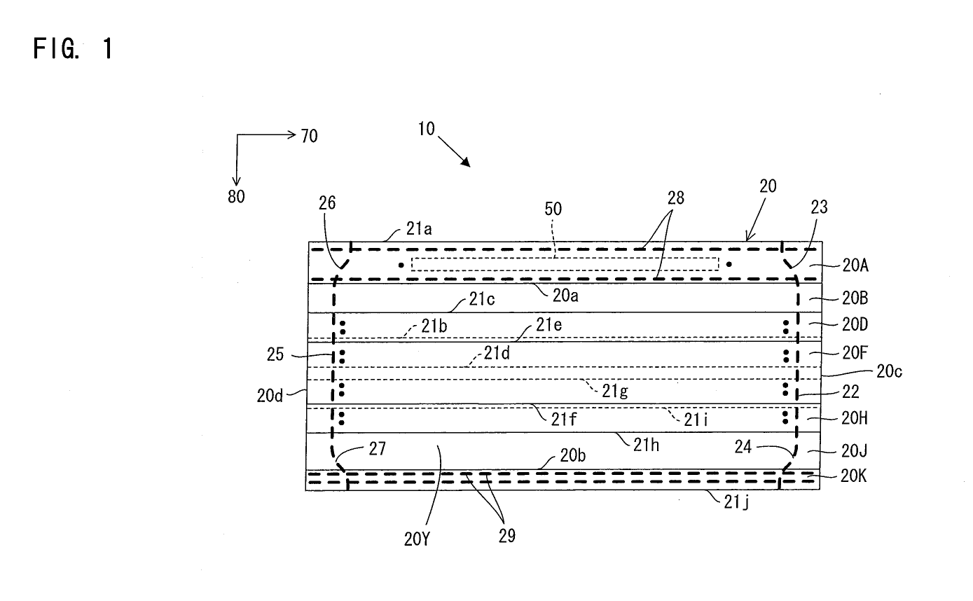

A mask 10 according to an embodiment of the present invention is now explained with reference to FIGS. 1 to 6. The mask 10 of this embodiment is designed as a disposable mask for single or multiple use which can be used once or several times. Further, the mask 10 of this embodiment can be used for various purposes including protection against pollens, protection against viruses such as cold viruses, and environmental improvement such as moisture retention around the mouth and in the nose.

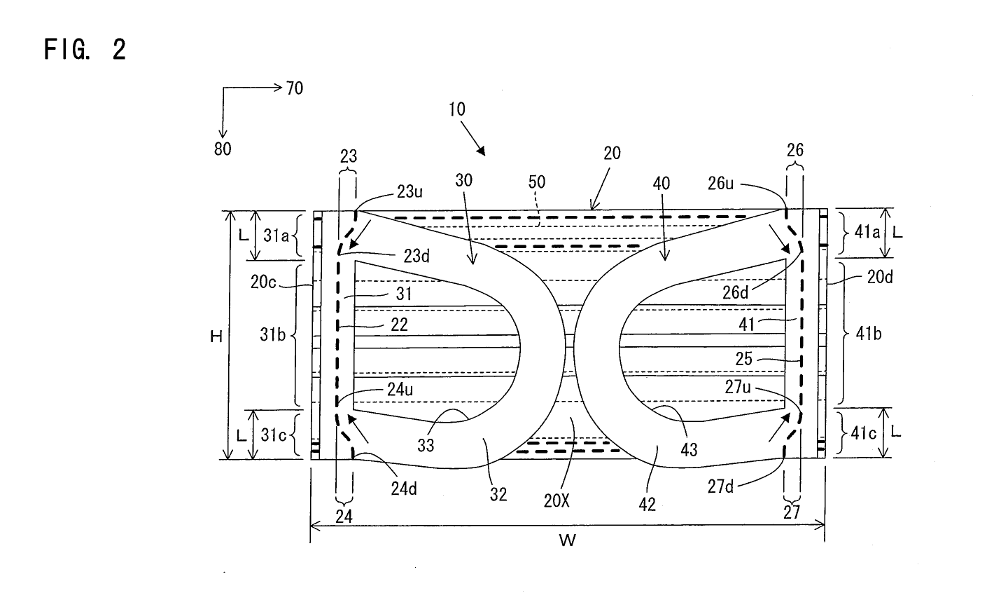

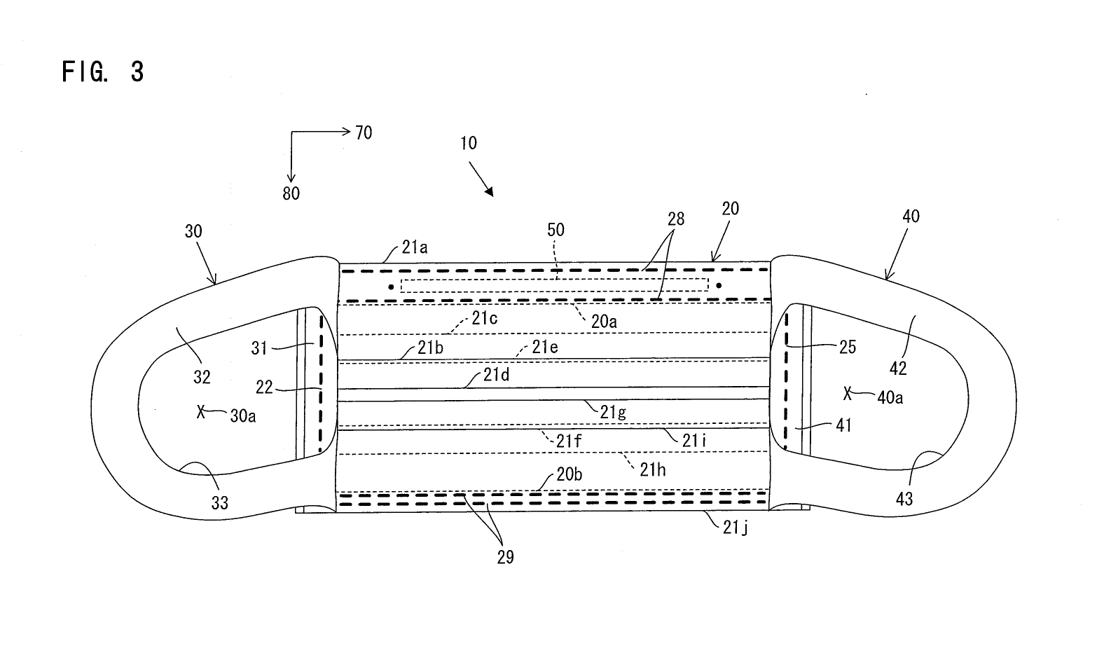

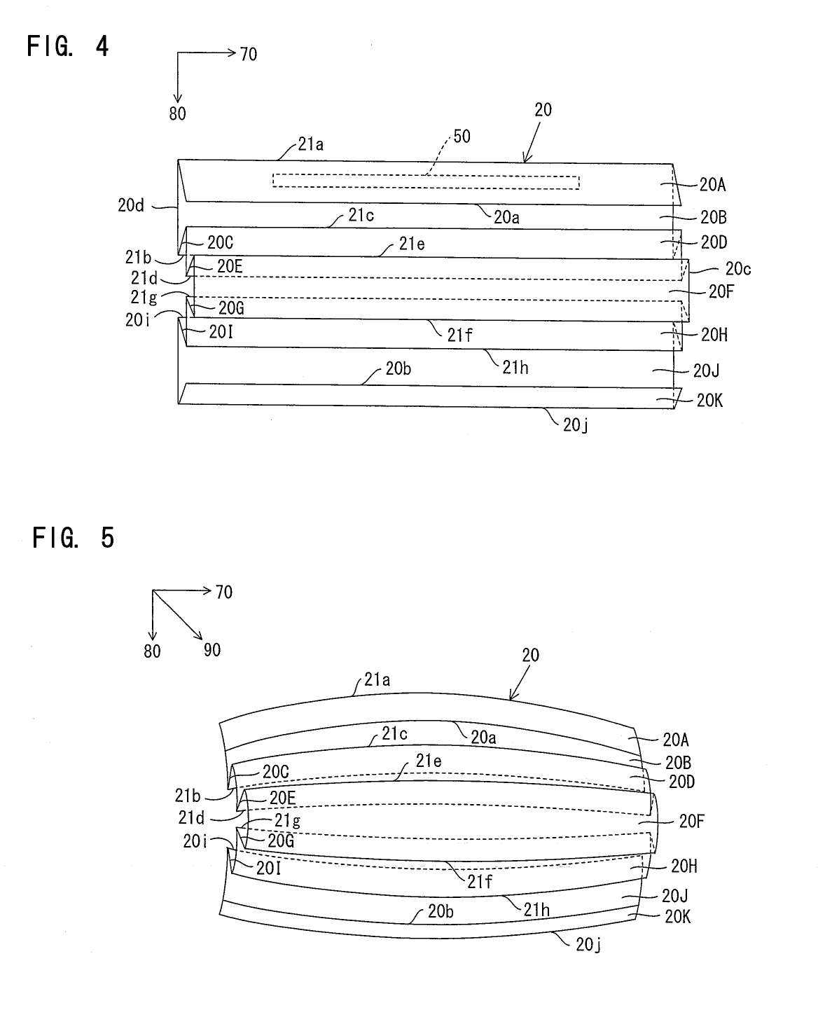

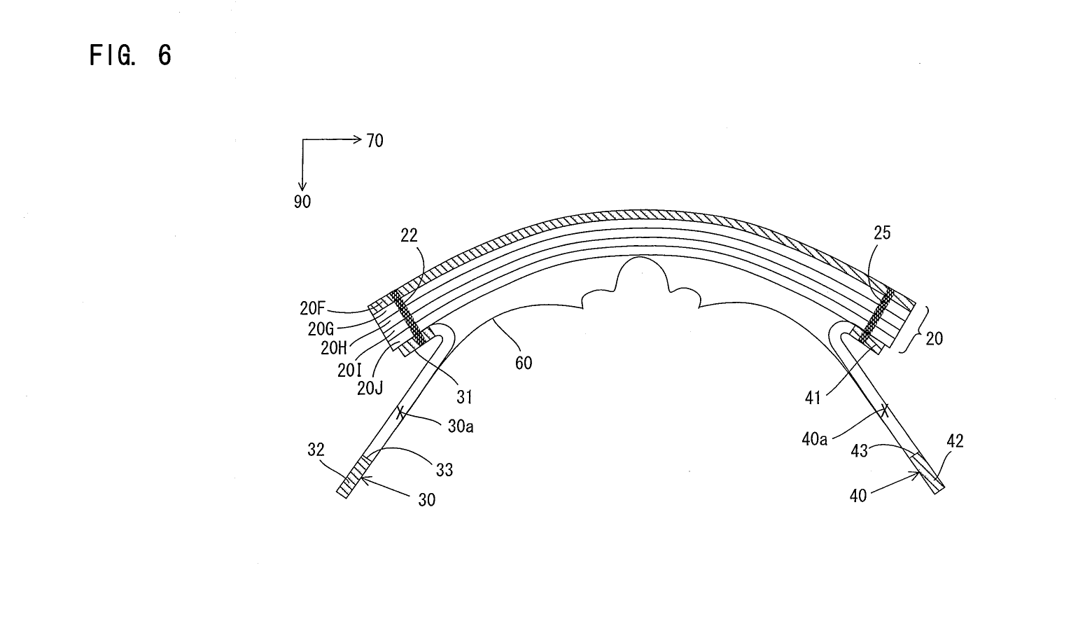

FIG. 1 shows the mask 10 of this embodiment as viewed from a non-wearing face 20Y side (opposite to a wearing face 20X side) when the mask is not worn, and FIG. 2 shows the mask 10 of this embodiment as viewed from the wearing face 20X side when the mask is not worn. FIG. 4 shows a mask body 20 when the mask is not worn, and FIG. 5 shows the mask body 20 when the mask is worn. FIG. 6 is a sectional view taken along line VI-VI in FIG. 3 as viewed from the direction shown by the arrow.

In this specification, “directions” are defined as follows.

A “first direction 70” represents a longitudinal direction (width direction) of a mask body 20 and corresponds to a horizontal direction when viewed from a wearer wearing the mask (which is referred to as the “horizontal direction”). One direction to “one side in the first direction 70” represents a direction from a left ear strap (a first ear strap) 30 toward a right ear strap (a second ear strap) 40 and corresponds to a direction from left to right when viewed from the wearer wearing the mask (which is referred to as the “right”). The other direction to “the other side in the first direction 70” represents a direction from the right ear strap (the second ear strap) 40 toward the left ear strap (the first ear strap) 30 and corresponds to a direction from right to left when viewed from the wearer wearing the mask (which is referred to as the “left”). Further, the “right” and the “left” here refer to the directions when viewed from the wearer wearing the mask. Therefore, when the “right” and the “left” are used herein for the mask as viewed from its non-wearing side, the “right” and the “left” are opposite to the actual “right” and “left”.

Further, a “second direction 80” represents a direction (a height direction) transverse to the longitudinal direction of the mask body 20 and corresponds to a vertical direction with respect to the wearer wearing the mask (which is referred to as the “vertical direction”). One direction to “one side in the second direction 80” represents a direction from an upper edge toward a lower edge of the mask body 20 and corresponds to a direction from top to bottom of the wearer wearing the mask (which is referred to as the “downward direction”). The other direction to “the other side in the second direction 80” represents a direction from the lower end toward the upper end of the mask body 20 and corresponds to a direction from down to top of the wearer wearing the mask (which is referred to as the “upward direction”).

Further, a “third direction 90” represents a front-back direction of the mask body 20 and corresponds to a front-back direction of the wearer wearing the mask (which is referred to as the “front-back direction”). One direction to the “one side in the third direction 90” represents a direction from a non-wearing face 20Y toward a wearing face 20X of the mask body 20 and corresponds to a direction from front to back of the wearer wearing the mask (which is referred to as the “backward direction”). The other direction to the “other side in the third direction 90” represents a direction from the wearing face 20X toward the non-wearing face 20Y and corresponds to a direction away from the wearer wearing the mask (which is referred to as the “frontward direction”).

As shown in FIGS. 1 and 2, the mask 10 of this embodiment includes a mask body 20, a left ear strap 30 and a right ear strap 40. The mask body 20 is designed to cover the mouth and nose of a wearer. The left ear strap 30 and the right ear strap 40 are designed to be hooked around the left and right ears of the wearer, respectively. The mask body 20, the left ear strap 30 and the right ear strap 40 are features that correspond to the “mask body”, the “first ear strap” and the “second ear strap”, respectively, according to this invention.

The mask body 20 has a plurality of pleats extending along the first direction 70 (the horizontal direction) and is configured as a pleated mask body. In this embodiment, as shown in FIG. 4, a rectangular sheet piece having an upper side 20a, a lower side 20b, a left side 20c and a right side 20d is folded in order along a plurality of folding lines 21a to 21j which extend in parallel to the upper side 20a and the lower side 20b (in parallel to the first direction 70). Thus, a plurality of pleats 20B to 20J extending along the first direction 70 are arranged along the second direction 80 (the vertical direction). When the mask is not worn, the mask body 20 has a rectangular shape having a width W in the first direction 70 and a height H in the second direction 80. Naturally, the shape of the mask body 20 is not limited to the rectangular shape.

Further, a shape retaining part 50 is held by a folded piece 20A folded back along the folding line 21a and the pleat 20B. When the mask is worn, the shape retaining part 50 serves to fit an upper end portion of the mask body 20 to contours of the wearer's face in order to reduce space between the mask body 20 and the wearer's face. The shape retaining part 50 is preferably provided such that it can be easily bent and has a sufficient rigidity for retaining the bent shape. For example, the shape retaining part 50 is formed by a thin plate made of synthetic resin or metal. The shape retaining part 50 is held on the mask body 20 by a variety of methods. In this embodiment, as shown in FIG. 1, the shape retaining part 50 is held by bonding the folded piece 20A and the pleat 20B by a bonding part 28 shown by a broken line and a bonding part shown by a black dot.

Further, a folded piece 20K folded back along a folding line 21j is bonded to the pleat 20J by a bonding part 29.

Adjacent pleats are bonded together at opposite ends in the first direction 70 by a left bonding part 25 and a right bonding part 24 which are described below.

The mask body 20 is preferably formed by nonwoven fabric sheets which are formed of thermoplastic fibers and stacked in three layers of an outer layer on the side facing away from the wearer, a filter layer (intermediate layer), and an inner layer on the side facing the wearer. The nonwoven fabric sheet may be manufactured, for example, by through-air bonding, spun bonding, thermal bonding, spun lacing, point bonding, melt blowing, stitch bonding, chemical bonding, needle punching or other similar methods by using fibers such as polyethylene, polypropylene or polyethylene terephthalate. Further, the nonwoven fabric sheet having a basis weight of 10 to 150 g/m² is used. Preferably, the nonwoven fabric sheet forming the outer layer and the inner layer has high air-permeability and is nice and soft to wear, and the nonwoven fabric sheet forming the filter layer has high air-permeability and high barrier properties (trapping efficiency).

In this embodiment, each of the left ear strap 30 and the right ear strap 40 is bonded to the mask body 20 on the wearing face 20X (the face on the wearer side) of the mask body 20.

In this embodiment, the mask body 20 and the left and right ear straps 30, 40 are separately formed. The mask body 20 however may also be integrally formed together with the left and right ear straps 30, 40. For example, the left and right ear straps 30, 40 may be overlaid on top of the mask body 20 by folding back one sheet piece.

Each of the left and right ear straps 30, 40 is formed of a sheet piece. Like the mask body 20, a nonwoven fabric sheet formed of thermoplastic synthetic fibers can be used as the sheet piece for forming the left and right ear straps 30, 40, and preferably, a nonwoven fabric sheet having higher stretchiness is used. For example, nonwoven fabric sheets having a basis weight of 30 to 120 g/m², such as a stretch SB nonwoven fabric sheet (spun-bonded nonwoven fabric sheet), a stretch SMS nonwoven fabric sheet (spun-bonded/melt-blown composite nonwoven fabric sheet), a (stretch SB-film-SB) nonwoven fabric sheet, a stretch spun-laced nonwoven fabric sheet or a stretch hot-melt-adhesive (HMA) nonwoven fabric sheet, are used.

The left ear strap 30 has a base 31 and a rim (ear strap part) 32 which extends from the base 31 and defines an opening 30a. The base 31 extends along the second direction 80 and has a middle base 31b, an upper base 31a and a lower base 31c. The upper base 31a extends in the other direction (upward) from the other end (upper end) of the middle base 31b in the second direction 80. The lower base 31c extends in one direction (downward) from one end (lower end) of the middle base 31a in the second direction 80. The rim (ear strap part) 32 extends from the upper and lower bases 31a, 31c. The opening 30a is formed by a cutout 33. The rim (ear strap part) 32 is designed to be hooked around the wearer's left ear through the opening 30a. The base 31 and the rim (ear strap part) 32 are features that correspond to the “first base” and the “first rim”, respectively, according to the present invention. Further, the upper base 31a, the middle base 31b and the lower base 31c are features that correspond to the “first upper base”, the “first middle base” and the “first lower base”, respectively, according to the present invention.

The left ear strap 30 is disposed on the other (left) end region of the wearing face 20X of the mask body 20 in the first direction 70 such that the rim 32 is located on one side (right) of the base 31 in the first direction 70.

Then the base 31 of the left ear strap 30 is bonded in part to the mask body 20 by a left bonding part. The left bonding part consists of linear or point-like bonding portions formed along the second direction 80. In this embodiment, part of the base 31 is bonded to the mask body 20 at the upper base 31a, the middle base 31b and the lower base 31c by the left bonding part. Specifically, the left bonding part includes an upper bonding part 23 for bonding the upper base 31a to the mask body 20, a middle bonding part 22 for bonding the middle base 31b to the mask body 20 and a lower bonding part 24 for bonding the lower base 31c to the mask body 20. The left bonding part is formed such that a portion of the ear strap on the rim 32 side of the left bonding part can be folded back along the region of the left bonding part in the first direction 70. The left bonding part, the upper bonding part 23, the middle bonding part 22 and the lower bonding part 24 are features that correspond to the “first bonding part”, the “first upper bonding part”, the “first middle bonding part” and the “first lower bonding part”, respectively, according to the present invention.

Like the left ear strap 30, the right ear strap 40 has a base 41 and a rim (ear strap part) 42 which extends from the base 41 and defines an opening 40a. The base 41 has an upper base 41a, a middle base 41b and a lower base 41c which are disposed in order from the other side to one side in the second direction 80. The rim (ear strap part) 42 extends from the upper and lower bases 41a, 41c. The opening 40a is formed by a cutout 43. The rim (ear strap part) 42 is designed to be hooked around the wearer's right ear through the opening 40a. The base 41 and the rim (ear strap part) 42 are features that correspond to the “second base” and the “second rim”, respectively, according to the present invention. Further, the upper base 41a, the middle base 41b and the lower base 41c are features that correspond to the “second upper base”, the “second middle base” and the “second lower base”, respectively, according to the present invention.

The right ear strap 40 is disposed on the one (right) end region of the wearing face 20X of the mask body 20 in the first direction 70 such that the rim 42 is located on the other side (left) of the base 41 in the first direction 70.

The base 41 of the right ear strap 40 is then bonded to the mask body 20 by a right bonding part. The right bonding part consists of linear or point-like bonding portions arranged along the second direction 80. In this embodiment, part of the base 41 is bonded to the mask body 20 in the upper base 41a, the middle base 41b and the lower base 41c by the right bonding part. Specifically, the right bonding part includes an upper bonding part 26 for bonding the upper base 41a to the mask body 20, a middle bonding part 25 for bonding the middle base 41b to the mask body 20 and a lower bonding part 27 for bonding the lower base 41c to the mask body 20. The right bonding part is formed such that a portion of the ear strap on the rim 42 side of the right bonding part can be folded back along the region of the right bonding part in the first direction 70. The right bonding part, the upper bonding part 26, the middle bonding part 25 and the lower bonding part 27 are features that correspond to the “second bonding part”, the “second upper bonding part”, the “second middle bonding part” and the “second lower bonding part”, respectively, according to the present invention.

Further, the width of each of the upper base 31a (41a) and the lower base 31c (41c) of the left ear strap 30 (the right ear strap 40), or the width of each connection between the base 31 (41) and the rim (ear strap part) 32 (42) is set to be L. For example, a height H of the mask body 20 is set to be 70 to 110 mm and the width L of the upper base 31a (41a) and the lower base 31c (41c) is set to be 10 to 30 mm. Specifically, in this embodiment, the rim 32 (42) of the left ear strap 30 (the right ear strap 40) is configured as a band-like member having a certain width.

As described above, the left and right ear straps 30, 40 are disposed on the left and right end regions of the wearing face 20X of the mask body 20 in the first direction 70. Further, at this time, the rims (32, 42) are located inward of the base (31, 41) (toward the center of the mask body) in the first direction 70, or specifically, such that the rim 32 of the left ear strap 30 and the rim 42 of the right ear strap 40 are opposed to each other in the first direction 70. Then the base 31 of the left ear strap 30 is bonded in part to the mask body 20 by the left bonding part and the base 41 of the right ear strap 40 is bonded in part to the mask body 20 by the right bonding part.

When the mask is not worn, the left ear strap 30 and the right ear strap 40 are overlaid on the wearing face 20X of the mask body 20, so that the mask 10 becomes substantially as small as the mask body 20 in size (area). Therefore, when the mask is not worn (not in use), the mask is easy to pack and easy to carry.

Next, the process of putting on the mask 10 according to this embodiment is now explained.

In the state shown in FIGS. 1 and 2, central regions of the pleats 20B, 20J on the both ends of the mask body 20 in the second direction 80 are pulled along the second direction 80. Thus, as shown in FIG. 5, the central regions of the pleats 20B to 20J of the mask body 20 in the first direction 70 expand in the second direction 80. At this time, a distance between the central pleat 20F and the pleats 20A, 20K on the both ends of the mask body 20 is widened in a third direction 90 (front-back direction). Specifically, the mask body 20 takes a three-dimensional form.

Further, as shown in FIGS. 3 and 6, the left ear strap 30 and the right ear strap 40 are folded back in the first direction 70 (the horizontal direction). Specifically, the rim 32 of the left ear strap 30 is folded back to the left in the first direction 70. Thus, a portion of the left ear strap 30 on the rim 32 side of the left bonding part is folded back along the region of the left bonding part. Further, the rim 42 of the right ear strap 40 is folded back to the right in the first direction 70, so that a portion of the right ear strap 40 on the rim 42 side of the right bonding part is folded back along the region of the right bonding part.

Then the left ear strap 30 is hooked around the wearer's left ear through the opening 30a and the right ear strap 40 is also hooked around the wearer's right ear through the opening 40a.

At this time, part of the folded portion of the left ear strap 30 is disposed between the left bonding part and a wearer 60. Specifically, the left bonding part is covered by the part of the folded portion of the left ear strap 30. Further, part of the folded portion of the right ear strap 40 is disposed between the right bonding part and the wearer 60. Specifically, the right bonding part is covered by the part of the folded portion of the right ear strap 40.

Thus, when the mask is worn, the left and right bonding parts can be prevented from coming in direct contact with the skin of the wearer 60.

Further, in this embodiment, not only a portion of the upper base 31a of the left ear strap 30 on the rim 32 side of the upper bonding part 23 and a portion of the lower base 31c of the left ear strap 30 on the rim 32 side of the lower bonding part 24, but a portion of the middle base 31b of the left ear strap 30 on the rim 32 side of the middle bonding part 22 is folded back. With such a construction, the strength of bonding between the left ear strap 30 and the mask body 20 can be increased by providing the left bonding part between the upper base 31a and the lower base 31c, while the left bonding part is prevented from coming in contact with the wearer's skin. This is the same with the right ear strap 40.

Further, in this embodiment, as shown in FIG. 2, the upper and lower bonding parts 23 (26), 24 (27) in the upper and lower bases 31a (41a), 31c (41c) are arranged in a different manner from the middle bonding part 22 (25) in the middle base 31b (41b). The middle bonding part 22 (25) in the middle base 31b (41b) extends in the second direction 80 substantially at the same location in the first direction 70 (substantially in parallel to the second direction 80). On the other hand, the upper and lower bonding parts 23 (26), 24 (27) in the upper and lower bases 31a (41a), 31c (41c) extend in the second direction 80 in such a manner as to be displaced in position in the first direction 70.

In FIG. 2, the upper bonding part 23 has an upper bonding portion 23u on the other (upper) end in the second direction 80 and a lower bonding portion 23d on one (lower) end in the second direction 80, and the lower bonding portion 23d is disposed to the opposite side of the upper bonding portion 23u from the rim 32 in the first direction 70. The upper bonding part 26 has an upper bonding portion 26u on its upper end in the second direction 80 and a lower bonding portion 26d on its lower end in the second direction 80, and the lower bonding portion 26d is disposed to the opposite side of the upper bonding portion 26u from the rim 42 in the first direction 70. Further, an appropriate bonding part is formed between the upper bonding portion 23u (26u) and the lower bonding portion 23d (26d).

Further, the lower bonding part 24 has an upper bonding portion 24u on its upper end in the second direction 80 and a lower bonding portion 24d on its lower end in the second direction 80, and the upper bonding portion 24u is disposed to the opposite side of the lower bonding part 24 from the rim 32 in the first direction 70. The lower bonding part 27 has an upper bonding portion 27u on its upper end in the second direction 80 and a lower bonding portion 27d on its lower end in the second direction 80, and the upper bonding portion 27u is disposed to the opposite side of the lower bonding part 27 from the rim 42 in the first direction 70. Further, a bonding part having an appropriate shape is formed between the upper bonding portion 24u (27u) and the lower bonding portion 24d (27d).

Further, the shape and location (in the first direction 70) of the left and right bonding parts can be appropriately selected, but preferably they are selected such that the left and right bonding parts can be covered by part of the portion folded back along the regions of the left and right bonding parts.

Thus, in this embodiment, the upper bonding part 23 of the left bonding part is gradually displaced in position to the other side (left) in the first direction 70 from the upper bonding portion 23u on the upper end in the second direction 80 to the lower bonding portion 23d on the lower end in the second direction 80. The upper bonding part 26 of the right bonding part is gradually displaced in position to the one side (right) in the first direction 70 from the upper bonding portion 26u on the upper end in the second direction 80 to the lower bonding portion 26d on the lower end in the second direction 80. With such a construction, when the mask is worn, space can be prevented from being formed between the mask body 20 and the wearer in the regions of the upper bases 31a and 41a.

Further, the lower bonding part 24 of the left bonding part is gradually displaced in position to the other side (left) in the first direction 70 from the lower bonding portion 24d on the lower end in the second direction 80 to the upper bonding portion 24u on the upper end in the second direction 80. The lower bonding part 27 of the right bonding part 25 is gradually displaced in position to the one side (right) in the first direction 70 from the lower bonding portion 27d on the lower end in the second direction 80 to the upper bonding portion 27u on the upper end in the second direction 80. With such a construction, when the mask is worn, space can be prevented from being formed between the mask body 20 and the wearer in the regions of the lower bases 31c and 41c.

Further, when the mask is worn, space is easily formed in the regions of the upper bases 31a and 41a. Therefore, only the upper bonding part 23 of the left bonding part 22 and the upper bonding part 26 of the right bonding part 25 may be formed such that their upper and lower bonding portions are displaced from each other in position in the first direction 70.

The upper bonding parts (23, 26) and the lower bonding part (24, 27) can be formed in appropriate shapes, but preferably their end portions in the second direction 80 are formed perpendicularly (or substantially perpendicularly) to a direction in which the rim 32 (42) is folded back. Specifically, the upper bonding part 23 (26) has an upper end region in the second direction 80 which extends from the upper bonding portion 23u (26u) in parallel (or substantially parallel) to the second direction 80. Further, the lower bonding part 24 (27) has a lower end region in the second direction 80 which extends from the lower bonding portion 24d (27d) in parallel (or substantially parallel) to the second direction 80.

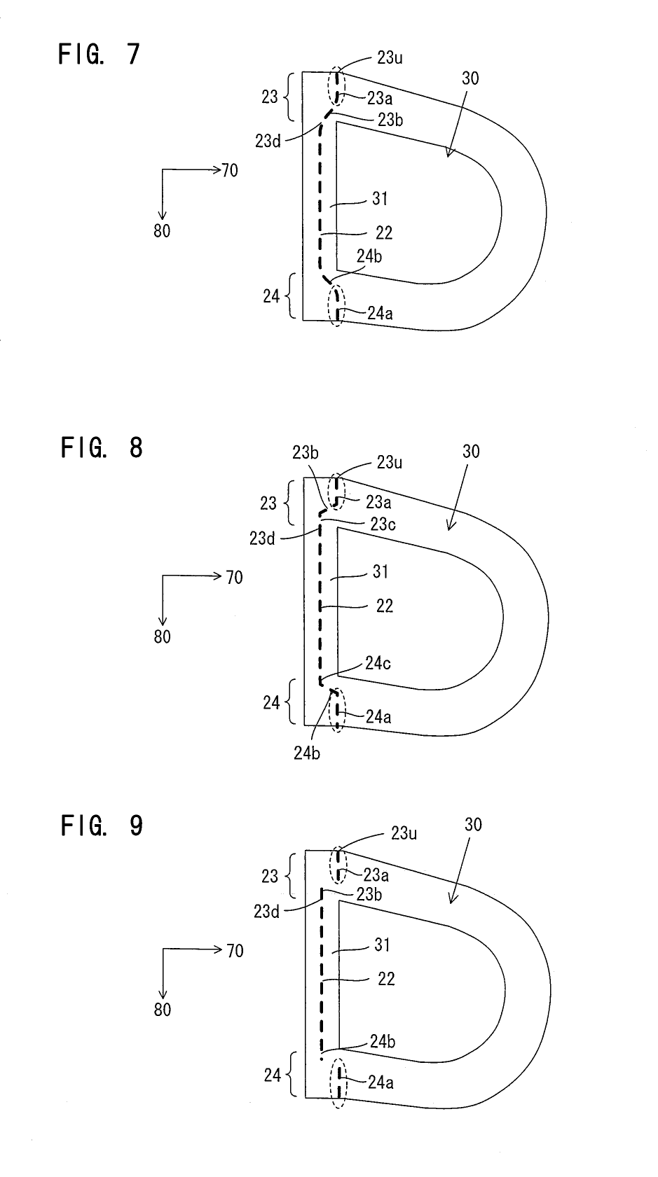

For example, the upper bonding part 23 shown in FIG. 7 has a bonding portion 23a formed in parallel (or substantially parallel) to the second direction 80 in a region (shown surrounded by a broken line) extending from the upper bonding portion 23u, and a bonding portion 23b formed along a curved line.

Further, the upper bonding part 23 shown in FIG. 8 has a bonding portion 23a which is formed in parallel (or substantially parallel) to the second direction 80 in a region (shown surrounded by a broken line) extending from the upper bonding portion 23u, and bonding portions 23b, 23c formed along a stepped line.

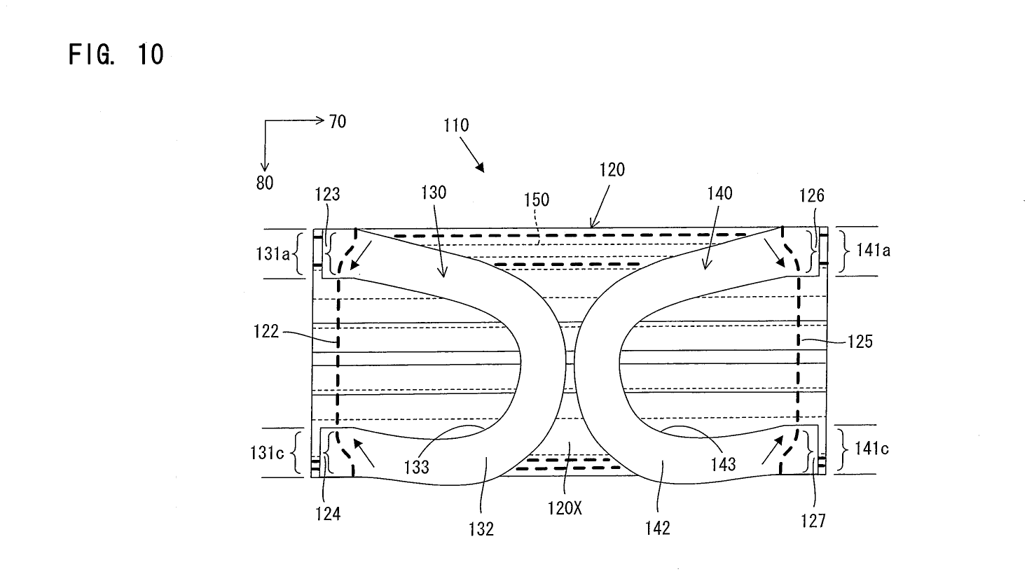

Further, the upper bonding part 23 shown in FIG. 9 has a bonding portion 23a which extends parallel (or substantially parallel) to the second direction 80 in a region (shown surrounded by a broken line) extending from the upper bonding portion 23u, and a bonding portion 23b formed parallel (or substantially parallel) to the second direction 80 (the bonding portions 23a and 23b are discontinuously formed).

With this construction in which the end portions of the upper bonding parts (23, 26) and the lower bonding parts (24, 27) in the second direction 80 are formed perpendicularly to the folding direction of the rim 32 (42) (the first direction 70), the upper bonding part (23, 26) and the lower bonding part (24, 27) increase in strength against tensile stress exerted in the folding direction (the first direction 70).

In the above-described embodiment, the left ear strap 30 (the right ear strap 40) has the base 31 (41) including the upper base 31a (41a), the middle base 31b (41b) and the lower base 31c (41c) which are disposed in order from the other side to the one side (from top to bottom) in the second direction 80, but the configuration of the base 31 (41) is not limited to this.

A mask 110 according to another embodiment of the present invention is shown in FIG. 10.

The mask 110 of this embodiment has a mask body 120 and left and right ear straps 130, 140. The mask body 120 has the same construction as the above-described mask body 20.

The left ear strap 130 has a base including an upper base 131a and a lower base 131c which are located away from each other in the second direction 80 and a rim 132 extending from the upper base 131a and the lower base 131c. Further, the left ear strap 130 has an opening 130a formed by a cutout 133. The left ear strap 130 is disposed on the other (left) end region of a wearing face 120X of a mask body 120 in the first direction 70 such that a rim 132 is located on one side (right) of the upper and lower bases 131a, 131c in the first direction 70. Then part of the upper base 131a and part of the lower base 131c are bonded to the mask body 120 by the left bonding part. The left bonding part includes an upper bonding part 123 for bonding the upper base 131a to the mask body 120, a lower bonding part 124 for bonding the lower base 131c to the mask body 120 and a middle bonding part 122 for bonding pleats 20B to 20J of the mask body 120.

The right ear strap 140 has a base including an upper base 141a and a lower base 141c which are located away from each other in the second direction 80 and a rim 142 extending from the upper base 141a and the lower base 141c. Further, in the right ear strap 140, an opening 140a is formed by a cutout 143. The right ear strap 140 is disposed on the one (right) end region of the wearing face 120X of the mask body 120 in the first direction 70 such that the rim 142 is located on the other side (left) of the upper and lower bases 141a, 141c in the first direction 70. Then part of the upper base 141a and part of the lower base 141c are bonded to the mask body 120 by the right bonding part. The right bonding part has an upper bonding part 126 for bonding the upper base 141a to the mask body 120, a lower bonding part 127 for bonding the lower base 141c to the mask body 120 and a middle bonding part 125 for bonding the pleats 20B to 20J of the mask body 120.

The upper bonding part 123 (126) and the lower bonding part 124 (127) of the left bonding part (the right bonding part) are formed such that a portion of the ear strap on the rim 132 (142) side of the upper bonding part 123 (126) and the lower bonding part 124 (127) can be folded back along the regions of the upper bonding part 123 (126) and the lower bonding part 124 (127).

In order to put on the mask 110 of this embodiment, a portion of the left ear strap 130 on the rim 132 side of the upper and lower bonding parts 123, 124 is folded back along the regions of the upper and lower bonding parts 123, 124. Likewise, a portion of the right ear strap 140 on the rim 142 side of the upper and lower bonding parts 126, 127 is folded back along the regions of the upper and lower bonding parts 126, 127. Thus, the upper and lower bonding parts 123, 124 are covered by part of the folded portion on the rim 132 side of the upper and lower bonding parts 123, 124. Likewise, the upper and lower bonding parts 126, 127 are covered by part of the folded portion on the rim 142 side of the upper and lower bonding parts 126, 127.

In this embodiment, a region of the left bonding part (the right bonding part) between the upper bonding part 123 (126) and the lower bonding part 124 (127) is not covered, but regions of the upper bonding part 123 (126) and the lower bonding part 124 (127) are covered. With such a construction, when the mask is worn, the upper bonding part 123 (126) and the lower bonding part 124 (127) can be prevented from coming in contact with the wearer's skin. Even such a mask can be more comfortable to wear than the known mask.

Further, when the mask is worn, space can be prevented from being formed between the mask body 20 and the wearer in the regions of the upper bases 131a and 141a and also in the regions of the lower bases 131c and 141c.

Further, the shape of the base 131 (141) between the upper base 131a (141a) and the lower base 131c (141c) can be appropriately changed.

The present invention is not limited to the above-described embodiments, but rather, may be added to, changed, replaced with alternatives or otherwise modified.

The mask body, the left ear strap and the right ear strap can be formed in various configurations. For example, the mask body may be designed to take a three-dimensional form at least when the mask is worn, or to be always held in a planar form.

The mask body, the left ear strap and the right ear strap can be formed by using various materials and methods. Further, the mask body, the left ear strap and the right ear strap can be bonded together by using various methods.

The pleats of the mask body can be appropriately changed in shape.

The left and right bonding parts can be appropriately changed in shape and position. Further, the bonding part can be continuously formed, or it can be formed from differently shaped bonding portions which are discontinuously arranged.

Each of the features or structures explained in the embodiments can be used singly or in combination with other appropriately selected ones.

Further, following aspects can be provided according to the invention.

### (Aspect 1)

A mask comprising a mask body which covers a wearer's mouth, and first and second ear straps which are designed to be hooked around wearer's ears, the first and second ear straps being bonded to the mask body by a first bonding part and a second bonding part, respectively, which are located away from each other in a first direction, wherein:

the first ear strap has a first base and a first rim which extends from the first base and defines an opening,

at least part of the first base is bonded to one face of the mask body by the first bonding part,

the first rim extends from the first base to one side in the first direction, and

the second ear strap has a second base and a second rim which extends from the second base and defines an opening,

at least part of the second base is bonded to the one face of the mask body by the second bonding part, and

the second rim extends from the second base to the other side in the first direction, and

at least when the mask is worn, the first ear strap is folded back at a region of the first bonding part in the first direction and the second ear strap is folded back at a region of the second bonding part in the first direction.

### (Aspect 2)

The mask as defined in aspect 1, wherein:

the first base has a first lower base and a first upper base which are located away from each other in a second direction transverse to the first direction, the first lower base being disposed to one side of the first upper base in the second direction,

the first rim extends from the first upper base and the first lower base,

at least part of the first upper base and at least part of the first lower base are bonded to the one face of the mask body by the first bonding part,

the second base has a second lower base and a second upper base which are located away from each other in the second direction transverse to the first direction, the second lower base being disposed to one side of the second upper base in the second direction,

the second rim extends from the second upper base and the second lower base, and

at least the part of the second upper base and at least the part of the second lower base are bonded to the one face of the mask body by the second bonding part.

### (Aspect 3)

The mask as defined in aspect 1, wherein:

the first base has a first upper base, a first middle base and a first lower base which are disposed in order from the other side to one side in a second direction transverse to the first direction,

the first rim extends from the first upper base and the first lower base,

at least the part of the first base is bonded to the one face of the mask body at the first upper base, the first middle base and the first lower base by the first bonding part,

the second base has a second upper base, a second middle base and a second lower base which are disposed in order from the other side to the one side in the second direction,

the second rim extends from the second upper base and the second lower base, and

at least the part of the second base is bonded to the one face of the mask body at the second upper base, the second middle base and the second lower base by the second bonding part.

### (Aspect 4)

The mask as defined in aspect 2 or 3, wherein:

the first bonding part which bonds the first upper base to the one face of the mask body is provided such that an end portion of the first bonding part on the one side in the second direction is disposed to the other side in the first direction with respect to an end portion of the first bonding part on the other side in the second direction, and

the second bonding part which bonds the second upper base to the one face of the mask body is provided such that an end portion of the second bonding part on the one side in the second direction is disposed to the one side in the first direction with respect to an end portion of the second bonding part on the other side in the second direction.

### (Aspect 5)

The mask as defined in any one of aspects 1 to 4, wherein:

the first bonding part and the second bonding part are provided along the second direction

### (Aspect 6)

The mask as defined in any one of aspects 1 to 5, wherein:

at least when the mask is worn, part of the first ear strap is disposed between the first bonding part and the wearer, and part of the second bonding part is disposed between the second bonding part and the wearer.

### (Aspect 7)

The mask as defined in any one of aspects 1 to 6, wherein:

the mask body has a plurality of pleats extending in the first direction, the pleats being bonded together at one end on one side in the first direction by the first bonding part and also at the other end on the other side in the first direction by the second bonding part,

the first rim extends in a band-like form from the first base, and

the second rim extends in a band-like form from the second base.

### (Aspect 8)

A mask, including a mask body that covers a wearer's mouth, a first ear strap and a second ear strap which are designed to be hooked around wearer's ears, the first and second ear straps being bonded to the mask body by first and second bonding parts, respectively, which are located away from each other in a first direction, wherein:

the first ear strap has a first base which is bonded at least in part to the mask body by the first bonding part and a first rim that extends from the first base and defines an opening,

the second ear strap has a second base which is bonded at least in part to the mask body by the second bonding part, and a second rim which extends from the second base and defines an opening,

at least when the mask is worn, part of the first ear strap is disposed between the first bonding part and the wearer, and part of the second bonding part is disposed between the second bonding part and the wearer.

### DESCRIPTION OF NUMERALS

10, 110 mask
20, 120 mask body
20a to 20d rim
20B to 20J pleat
20X wearing face (back)
20Y non-wearing face (front)
21a to 21j folding line
22, 25, 122, 125 middle bonding part
23, 123, 26, 126 upper bonding part
23u, 24u, 26u, 27u upper bonding portion
23d, 24d, 26d, 27d lower bonding portion
24, 124, 27, 127 lower bonding part
30, 130 left ear strap (first ear strap)
30a, 40a opening
31, 41 base
31a, 41a, 131a, 141a upper base
31b, 41b middle base
31c, 41c, 131c, 141c lower base
32, 42 rim
40, 140 right ear strap (second ear strap)
70 first direction (horizontal direction)
80 second direction (vertical direction)
90 third direction (front-back direction)

1. A mask comprising a mask body which covers a wearer's mouth, and first and second ear straps which are designed to be hooked around wearer's ears, the first and second ear straps being bonded to the mask body by a first bonding part and a second bonding part, respectively, which are located away from each other in a first direction, wherein:
the first ear strap has a first base and a first rim which extends from the first base and defines an opening,
at least part of the first base is bonded to one face of the mask body by the first bonding part,
the first rim extends from the first base to one side in the first direction, and the second ear strap has a second base and a second rim which extends from the second base and defines an opening,
at least part of the second base is bonded to the one face of the mask body by the second bonding part, and
the second rim extends from the second base to the other side in the first direction, and
at least when the mask is worn, the first ear strap is folded back at a region of the first bonding part in the first direction and the second ear strap is folded back at a region of the second bonding part in the first direction.

2. The mask as defined in claim 1, wherein:
the first base has a first lower base and a first upper base which are located away from each other in a second direction transverse to the first direction, the first lower base being disposed to one side of the first upper base in the second direction,
the first rim extends from the first upper base and the first lower base,
at least part of the first upper base and at least part of the first lower base are bonded to the one face of the mask body by the first bonding part,
the second base has a second lower base and a second upper base which are located away from each other in the second direction transverse to the first direction, the second lower base being disposed to one side of the second upper base in the second direction,
the second rim extends from the second upper base and the second lower base, and
at least the part of the second upper base and at least the part of the second lower base are bonded to the one face of the mask body by the second bonding part.

3. The mask as defined in claim 1, wherein:
the first base has a first upper base, a first middle base and a first lower base which are disposed in order from the other side to one side in a second direction transverse to the first direction,
the first rim extends from the first upper base and the first lower base, at least the part of the first base is bonded to the one face of the mask body at the first upper base, the first middle base and the first lower base by the first bonding part,
the second base has a second upper base, a second middle base and a second lower base which are disposed in order from the other side to the one side in the second direction,
the second rim extends from the second upper base and the second lower base, and
at least the part of the second base is bonded to the one face of the mask body at the second upper base, the second middle base and the second lower base by the second bonding part.

4. The mask as defined in claim 2, wherein:
the first bonding part which bonds the first upper base to the one face of the mask body is provided such that an end portion of the first bonding part on the one side in the second direction is disposed to the other side in the first direction with respect to an end portion of the first bonding part on the other side in the second direction, and
the second bonding part which bonds the second upper base to the one face of the mask body is provided such that an end portion of the second bonding part on the one side in the second direction is disposed to the one side in the first direction with respect to an end portion of the second bonding part on the other side in the second direction.

5. The mask as defined in claim 1, wherein:
the first bonding part and the second bonding part are provided along the second direction.

6. The mask as defined in claim 1, wherein:
at least when the mask is worn, part of the first ear strap is disposed between the first bonding part and the wearer, and part of the second bonding part is disposed between the second bonding part and the wearer.

7. The mask as defined in claim 1, wherein:
the mask body has a plurality of pleats extending in the first direction, the pleats being bonded together at one end on one side in the first direction by the first bonding part and also at the other end on the other side in the first direction by the second bonding part,
the first rim extends in a band-like form from the first base, and
the second rim extends in a band-like form from the second base.
